(19) United States
(12) Patent Application Publication
(10) Pub. No.: US 2013/0199079 A1
(43) Pub. Date: Aug. 8, 2013

(54) Realistic vinyl printed insect wings, body's, minnow heads, body's, beetle body's, and crab body's of every shape, size and color

(71) Applicant: Brent Onofrychuk, (US)

(72) Inventor: Brent Onofrychuk, (US)

(21) Appl. No.: 13/366,291

(22) Filed: Feb. 4, 2012

(51) Int. Cl. A01K 85/08

(52) U.S. Cl. 43/42.32; 43/42.37

(57) ABSTRACT

An insect wing, or body, a minnow head and body, a beetle body and a crab body, or any other product that represents what fish eat that is designed and printed on vinyl that looks and feels real. The product is designed to fit each type of hook or body case to give the lure, or hook its realistic appearance. The product is then used by fly fisherman to tie the product to their hooks to allow for their lure to look, act as a real insect, beetle, and minnow of crab or what fish eat. This product is not limited to fly fishermen, but to any customers that would be interested in this product.

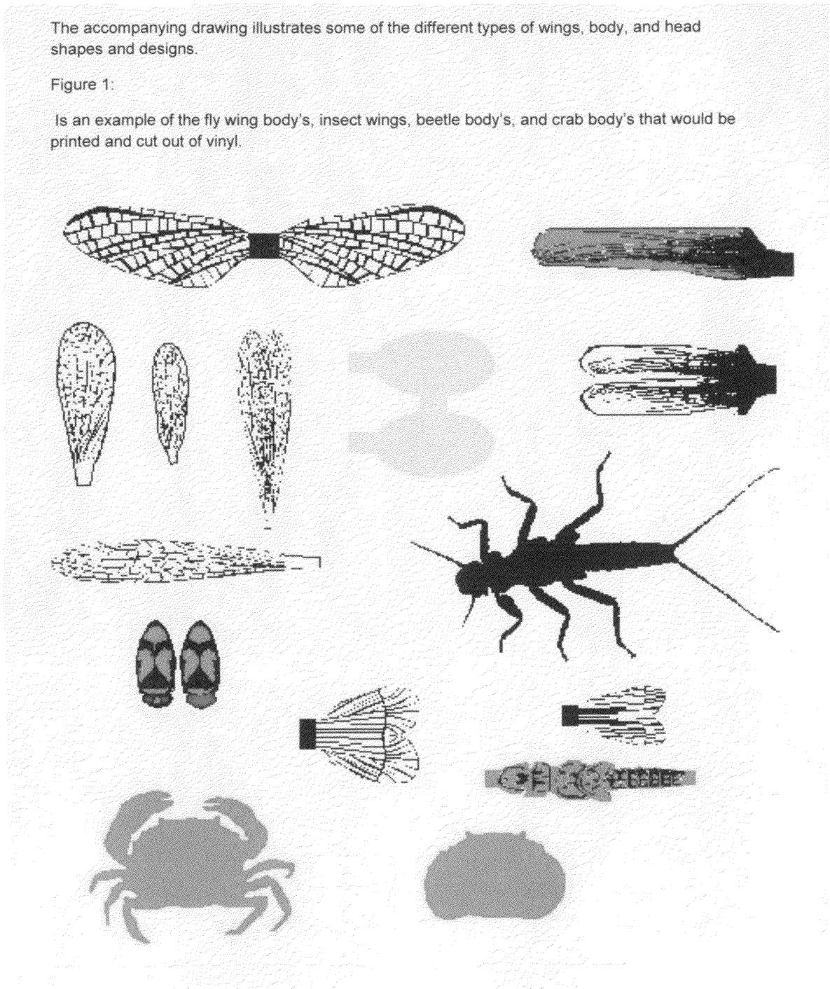

### BACKGROUND

Fly fishing is very popular all over the world. The hooks that are used are designed and produced using a combination of natural and artificial products such as latex, real feathers and furs to create a lure that represents a bug, insect, crab, beetle or any variety that looks and represents the natural food that fish eat.

To this point most commercial and individual fly tying have had difficulty producing realistic insects and the products that are in the market take a long extensive time to produce things like realistic wings and bodies.

### SUMMARY OF THE INVENTION

This invention allows the user to produce realistic flies and insects, crabs, all their bodies, and any other food that fish eat through having access to realistic vinyl printed and produced wings, bodies.

The wings are of every shape, color and size that are pre designed to fit the hook the end user has.

The beetle bodies are of every shape, color and size that fit the hook the end user has.

The minnow head and body is of every shape color and size to fit the hook of the end user

The crab body of every shape size and color can fit the hook of the end user.

Other product are being developed to represent all kinds of food that fish eat to allow anglers the ability to catch more fish, but this product is not limited to fishing.

The wings and the body designs can be produced from the photo or drawing of a real insect, bug, beetle, crab or minnow. Also there can be custom designs or veins, body, crab shell and minnow head configurations and shapes.

1. That there are no products on that market that replicate insect wings, body, beetle body, minnow head and body, and crab body, or any other food that fish eat using vinyl printed products both stick and non-sticky.

2. The product is unique and comes in all shapes, sizes, and colors.

3. The vinyl printed wings, body are used to tie onto hooks used for fishing. Specifically Fly fishing of every kinds and in Fresh and Salt water, but not limited to that market

4. That the drawing that is attached is a representation of some of the wings, heads and bodies that are produced but is not limited.

5. The patterns for the products are design through use of pictures of real insects, crabs, beetles or any other food source for fish to design the most realistic products that represent fish's food so that anglers can use the products to enhance and improve their lures to catch more fish.

6. The products used are vinyl that is commercially produced, both non-sticky back and sticky back vinyl and is used with any colors that represent the insect or food that is trying to be recreated.
